(19) United States
(12) Patent Application Publication
(10) Pub. No.: US 2002/0145707 A1
(43) Pub. Date: Oct. 10, 2002

(54) Illumination optical system and projection type color image display apparatus using the same

(75) Inventor: Kazuya Yoneyama, Saitama-shi (JP)

Correspondence Address: Ronald R. Snider, Snider & Associates, P.O. Box 27613, Washington, DC, 20038-7613, US

(73) Assignee: Fuji Photo Optical Co., Ltd., Saitama-shi (JP)

(21) Appl. No.: 10/095,452

(22) Filed: Mar. 13, 2002

(30) Foreign Application Priority Data
Mar. 22, 2001 (JP) 2001-083432

(51) Int. Cl. G03B 21/14

(52) U.S. Cl. 353/84

(57) ABSTRACT

In an illumination optical system comprising a reflector for reflecting illumination light emitted from a luminous body, and a color wheel for decomposing the illumination light into a plurality of color light components, the color wheel is arranged with a predetermined angle near a position where the illumination light attains the smallest luminous flux diameter or is arranged substantially orthogonal to the optical axis while being separated from the position where the illumination light attains the smallest luminous flux diameter by a predetermined distance along the optical axis.

### RELATED APPLICATIONS

This application claims the priority of Japanese Patent Application No. 2001-083432 filed on Mar. 22, 2001, which is incorporated herein by reference.

### BACKGROUND OF THE INVENTION

1. Field of the Invention

The present invention relates to an illumination optical system in a projection type image display apparatus which optically modulates illumination light by using an image display device and projects thus modulated illumination light under magnification. In particular, it relates to an illumination optical system comprising a color wheel as color decomposing means, and a projection type color image display apparatus using the same.

2. Description of the Prior Art

In illumination optical systems of projection type color image display apparatus, those comprising a color wheel apparatus as color decomposing means have recently been known. As compared with a conventional three-plate type color decomposing optical system, a color wheel apparatus is color decomposing means which has a lighter weight with a smaller size and is less expensive.

FIG. 6 shows an example of a typical color wheel apparatus. The depicted color wheel apparatus 20 comprises a disk-shaped color wheel body 20a made of glass having three sectored areas 37, 39, 41 which substantially equally divide its angle of circumference into three about its center. Each area is formed with a dichroic film which reflects or transmits its corresponding one color luminous flux of three primary color light components. The disk is rotated with a motor shaft 43a fixed to the center thereof, while illumination light is made incident on its peripheral area at a predetermined position. As a consequence, the illumination light enters the three areas 37, 39, 41 in succession, thereby being decomposed into individual color light components in a time-division manner.

In the case of a transmission type color wheel, for example, the illumination light is divided with time through the color wheel, so that three primary color light components are successively emitted one by one. Namely, about one third of the visible component of illumination light is always transmitted through the color wheel as an effective luminous flux so as to be directed to an image display device in a downstream stage, whereas the remaining about two thirds of light is always reflected so as to return toward the light source.

While images formed by thus time-divided individual color light components are projected on a screen in a time series, they can be recognized as a color image when their changing speed is made sufficiently faster than a human viewable speed. Therefore, when using this apparatus, the downstream image display device is desired to have a high response speed in order for the color image to be recognized on the screen. Preferable examples of such an image display device include digital micromirror devices, and ferroelectric liquid crystal display devices which are a kind of reflection type liquid crystal display devices.

In illumination optical systems using such a color wheel, the life of luminous tubes may become remarkably short. This is because of light reflected from the color wheel. In the transmission type color wheel, as mentioned above, about two thirds of the visible light component is always reflected so as to return toward the light source. When a large quantity of reflected light returns to a luminous tube of the light source section as such, the inside of the luminous tube is heated, which accelerates the deterioration of inner electrodes and the like.

FIG. 7 shows how light reflected by a color wheel returns to a luminous tube. As depicted, illumination light emitted from a luminous tube (indicated as a light-emitting point 11) disposed near a focal point of a parabolic reflector 12 is forwardly reflected by the parabolic reflector 12 as substantially parallel light beams. The lower half of illumination light beams from the optical axis in FIG. 7 are referred to with letters A to G successively from the one closest to the optical axis. The illumination light emitted from the light source section 1 is usually converged by a condenser lens 3, whereas a color wheel 2 is inserted perpendicularly to the optical axis at a position where the luminous flux diameter of illumination light is the smallest.

When the color wheel 2 is a transmission type, about one third of illumination light corresponding to one primary color is always transmitted as an effective luminous flux through the dichroic films of the color wheel 2, whereas about two thirds of light corresponding to the remaining two primary colors is always reflected by the dichroic films of the color wheel 2. Namely, about two thirds of the light quantity of the illumination light beams A to G is reflected so as to return toward the light source section. In FIG. 7, the illumination light transmitted through the color wheel 2 is not depicted.

FIG. 7 shows that most of the reflected light beams (A to F) reenter the reflector 12 and are collected near the light-emitting point 11 (reflector focal point) of the light source. The quantity of light (hereinafter referred to as “return light”) reflected by the color wheel 2 and then re-reflected by the reflector 12 so as to return to the vicinity of the light-emitting point 11, like light beams A to F, increases as such, whereby the temperature of luminous tube rises. Here, the outermost light beam G is reflected by the color wheel 2 and then is blocked by the rim of the condenser lens 3, thus failing to return to the vicinity of the light-emitting point 11. This is because of the spherical aberration of the condenser lens 3.

Not only the visible light not transmitted through the color wheel mentioned above, but also ultraviolet and infrared rays reflected by the color wheel become return light. These rays may also become problematic since they raise the temperature of the luminous tube when collected near the light-emitting point 11.

Japanese Unexamined Patent Publication No. 2000-305172 discloses a projection type display apparatus in which curved surfaces of lenses disposed in an optical path from a light source to an image display device are processed so as to reflect ultraviolet and infrared rays, in order to prevent these rays from returning to the light source. However, it is difficult for curved surfaces to be provided with a coating for reflecting ultraviolet and infrared rays, whereby favorable reflection characteristics are hard to obtain in general. Also, as mentioned above, not only the ultraviolet and infrared rays but also the visible light becomes return light when the color wheel is used as color decomposing means, whereby countermeasures are insufficient in the above-mentioned conventional example intended for reducing only the return light of ultraviolet and infrared rays.

### SUMMARY OF THE INVENTION

In view of such circumstances, it is an object of the present invention to provide an illumination optical system which can reduce return light in order to alleviate or eliminate the deterioration of luminous tubes caused by the return light when a color wheel is used, and a projection type color image display apparatus using the same.

The first aspect of the present invention provides an illumination optical system comprising a reflector for forwardly reflecting illumination light emitted from a luminous body, and a color wheel for decomposing the illumination light from the reflector into a plurality of color light components; wherein the color wheel is disposed with a predetermined angle with respect to an optical axis.

Preferably, the reflector comprises a parabolic mirror, the luminous body is disposed near a focal point of the parabolic mirror, a condenser lens for converging the illumination light from the reflector is provided, and the color wheel is disposed near a focal point of the condenser lens.

Preferably, the reflector comprises an ellipsoidal mirror, the luminous body is disposed near a first focal point of the ellipsoidal mirror, and the color wheel is disposed near a second focal point of the ellipsoidal mirror.

Preferably, the color wheel is a transmission type color wheel.

Preferably, the transmission type color wheel has a transmitting area equally divided into three for transmitting therethrough three primary color light components, respectively.

Preferably, the color wheel is a reflection type color wheel.

Preferably, the transmission type color wheel has a reflecting area equally divided into three for reflecting three primary color light components, respectively.

The present invention provides a projection type color image display apparatus comprising the above-mentioned illumination optical system, and an image display device for optically modulating the illumination light emitted from the illumination optical system.

Preferably, an integrator section for homogenizing an intensity distribution of said illumination light within a cross section perpendicular to the optical axis.

Preferably, the integrator section is a rod integrator.

Preferably, the integrator section is a flyeye integrator.

Preferably, a polarization converting device for converting the illumination light into light having only one polarized light component.

The second aspect of the present invention provides an illumination optical system comprising a light source section comprising a reflector made of a parabolic mirror, and a luminous body disposed near a focal point of the reflector; a condenser lens; and a color wheel for decomposing illumination light from the light source section into a plurality of color light components; wherein the color wheel is separated from a focal point of the condenser lens by a predetermined distance toward or away from the light source section along an optical axis.

The third aspect of the present invention provides an illumination optical system comprising a light source section comprising a reflector made of an ellipsoidal mirror, and a luminous body disposed near a first focal point of the reflector; and a color wheel for decomposing illumination light from the light source section into a plurality of color light components; wherein the color wheel is separated from a second focal point of the reflector by a predetermined distance toward or away from the light source section along an optical axis.

Preferably, at least one surface of the color wheel is formed with an infrared reflecting coat or an ultraviolet reflecting coat.

The present invention provides a projection type color image display apparatus comprising the above-mentioned illumination optical system, and an image display device for optically modulating the illumination light emitted from the illumination optical system.

Preferably, the image display device is a ferroelectric liquid crystal display device or digital micromirror device.

Preferably, in the illumination light decomposed into a plurality of color light components in the color wheel, a color light component transmitted through the color wheel is guided to the image display device.

The above-mentioned expression “the color wheel is disposed with a predetermined angle with respect to an optical axis” means that the color wheel is tilted from a position orthogonal to the optical axis to such an extent that the illumination light reflected by the color wheel is not re-reflected by the reflector and does not return to the luminous body of the light source section. On the other hand, the expressions “the color wheel is separated from a focal point of the condenser lens by a predetermined distance toward or away from the light source section along an optical axis” and “the color wheel is separated from a second focal point of the reflector by a predetermined distance toward or away from the light source section along an optical axis” mean that the color wheel substantially orthogonal to the optical axis is separated from the focal point of the condenser lens or the second focal point of the reflector made of an ellipsoidal mirror by a predetermined distance toward or away from the light source section to such an extent that the illumination light reflected by the color wheel is not re-reflected by the reflector and does not return to the luminous body of the light source section.

### BRIEF DESCRIPTION OF THE DRAWINGS

FIG. 1 is a view showing the configuration of the projection type color image display apparatus in accordance with Example 1;

FIGS. 2A and 2B are views for explaining a first embodiment of the illumination optical system in accordance with the present invention;

FIGS. 3A and 3B are views for explaining a second embodiment of the illumination optical system in accordance with the present invention;

FIG. 4 is a view for explaining a third embodiment of the illumination optical system in accordance with the present invention;

FIG. 5 is a view showing the configuration of the projection type color image display apparatus in accordance with Example 2;

FIG. 6 is a view showing the configuration of a color wheel apparatus; and

FIG. 7 is a view for explaining return light.

### DESCRIPTION OF THE PREFERRED EMBODIMENTS

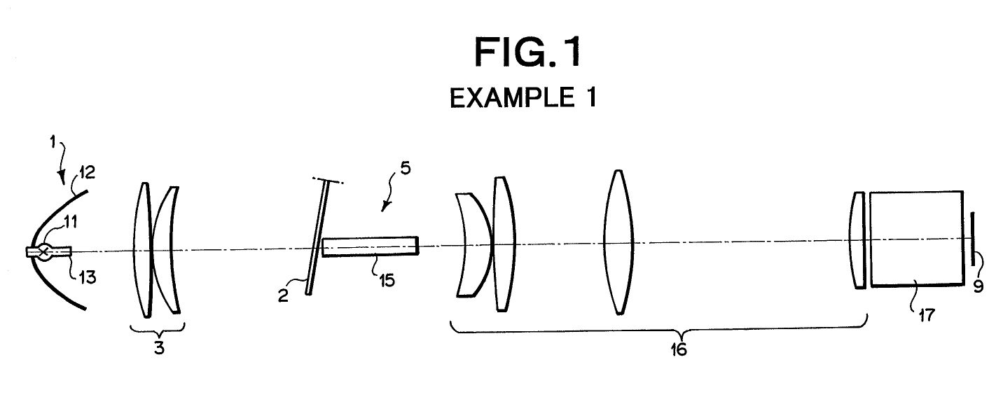

In the following, embodiments of the illumination optical system and projection type color image display apparatus using the same will be explained with reference to the drawings. FIG. 1 is a view showing the configuration of the projection type color image display apparatus in accordance with Example 1, which will be explained later, using the illumination optical system having the configuration of the first embodiment in accordance with the present invention.

This apparatus is a projection type color image display apparatus comprising an illumination optical system in which illumination light from a light source section 1 comprising a luminous tube 11 disposed near a focal point of a parabolic reflector 12 is guided to an image display device 9 by way of a condenser lens 3 and a color wheel 2, disposed near a focal point of the condenser lens 3, for decomposing the illumination light from the light source section 1 into color light components. The illumination light is optically modulated in the image display device 9, and thus modulated light is projected through a projection lens (not depicted). In addition, an integrator section 5, a relay lens 16, and a total reflection prism 17 are disposed between the light source section 1 and the image display device 9.

In this illumination optical system, the color wheel 2 is a transmission type as depicted, and is disposed so as to yield a predetermined angle with respect to the optical axis. Namely, the color wheel 2 is tilted from a position orthogonal to the optical axis to such an extent that the illumination light from the light source section 1 reflected by the color wheel 2 is not re-reflected by the reflector 12 and does not return to the luminous tube 11 of the light source section 1.

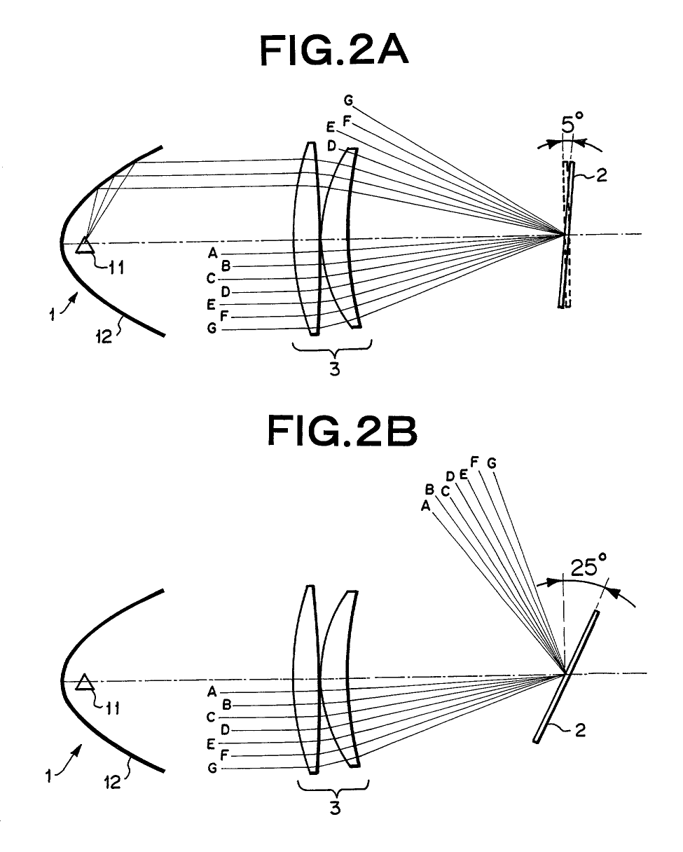

The reason why the color wheel 2 is tilted as such will now be explained with reference to FIGS. 2A and 2B. FIGS. 2A and 2B are views showing the illumination optical system in accordance with this embodiment from its light source section 1 to color wheel 2 under magnification. The color wheel 2 in FIG. 2A is tilted by 5 degrees from a position orthogonal to the optical axis. Namely, without changing the position on the optical axis, the color wheel 2 is rotated by 5 degrees from the above-mentioned state shown in FIG. 7.

In the light source section 1, the illumination light emitted from the luminous tube (indicated as a light-emitting point 11) disposed near the focal point of the parabolic reflector 12 is forwardly reflected as substantially parallel light beams by the parabolic reflector 12. The illumination light emitted from the light source section 1 is converged by the condenser lens 3, whereas the color wheel 2 is inserted at a position where thus converged illumination light attains the smallest luminous flux diameter. As in FIG. 7 mentioned above, the lower half of light beams from the optical axis emitted from the reflector aperture are traced with reference letters A to G successively from the one closest to the optical axis, without depicting the illumination light transmitted through the color wheel 2.

When the color wheel 2 is tilted from the position orthogonal to the optical axis, as shown in FIG. 2A, the quantity of light reflected by the color wheel 2 and then re-reflected by the reflector 12 so as to return to the vicinity of the light-emitting point 11 clearly becomes smaller than that in the state of FIG. 7. Namely, while the light beams A to F become return light in FIG. 7, only the light beams A to C become return light in FIG. 2A. Therefore, the temperature rise in the luminous tube 11 lowers, whereby electrodes and the like within the luminous tube can be restrained from deteriorating.

FIG. 2B shows a case where the color wheel is further tilted so as to form an angle of 25 degrees with respect to the position orthogonal to the optical axis. The color wheel 2 is disposed near the condenser lens 3 on the optical axis in this case as well. When the angle of inclination of the color wheel 2 is enhanced as such, no light is reflected by the color wheel 2 so as to return to the reflector, whereby the luminous tube is not heated by the return light. In order for the reflected light from the color wheel 2 to totally deviate from the reflector, it will be sufficient if the color wheel is tilted by at least a from the position orthogonal to the optical axis, where α is the angle formed between the optical axis and the outermost light beam emitted from the condenser lens 3 to the color wheel 2.

When the color wheel 2 is tilted by a predetermined angle with respect to the optical axis while using a reflector made of a parabolic mirror, the condenser lens 3 is not essential. The condenser lens 3 is used for reducing the size of the color wheel 2, whereas the color wheel 2 is generally disposed near the position (the focal point of the condenser lens 3) where the illumination light converged by the condenser lens 3 attains the smallest luminous flux diameter. However, a configuration in which parallel light beams are incident on the color wheel 2 from the light source section 1 without arranging the condenser lens 3 also reduces the return light by tilting the color wheel 2 as in the case mentioned above.

Preferably, at least one surface of the color wheel 2 is formed with an infrared reflecting coat. Preferably, at least one surface of the color wheel 2 is formed with an ultraviolet reflecting coat.

As mentioned above, when a color wheel is used as color decomposing means, visible light also becomes return light with a large quantity, which makes it important to reduce the return light of visible light. However, infrared and ultraviolet rays may also be made incident on the color wheel 2. When the color wheel 2 is formed with a coat for reflecting infrared and ultraviolet rays, these rays can be prevented from being transmitted through the color wheel 2. Also, these rays can be reflected so as to deviate from the reflector without returning to the vicinity of the luminous tube, since the color wheel 2 is tilted with respect to the optical axis. Therefore, the return light of infrared and ultraviolet rays can be restrained from raising the temperature of the luminous tube. Forming a coat on a plane such as that of the color wheel 2 is also easier than forming a coat on a curved surface, whereby better reflection characteristics can be obtained.

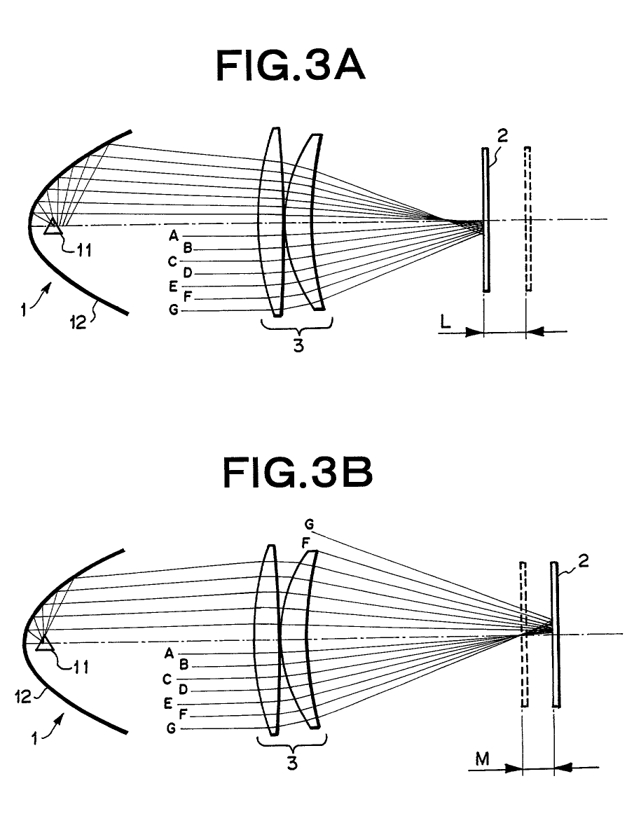

A second embodiment of the illumination optical system in accordance with the present invention will now be explained with reference to FIGS. 3A and 3B showing the illumination optical system from its light source section 1 to color wheel 2 under magnification. As with the illumination optical system in accordance with the first embodiment, the illumination optical system in accordance with the second embodiment can be employed in a projection type color image display apparatus. As in the first embodiment, the light source section 1 of the illumination optical system comprises a luminous tube (indicated as a light-emitting point 11) disposed near the focal point of a reflector 12 made of a parabolic mirror. Similarly, the illumination light from the light source section 1 is converged by the condenser lens 3.

In this embodiment, the color wheel 2 is arranged substantially orthogonal to the optical axis while being separated from the focal point of the condenser lens 3 by a predetermined distance toward or away from the light source section along the optical axis. Namely, the color wheel 2 is separated from the focal point of the condenser lens 3 by a predetermined distance toward or away from the light source section 1 along the optical axis to such an extent that the illumination light reflected by the color wheel 2 is not re-reflected by the reflector 12 and does not return to the luminous tube 11 of the light source section 1. FIG. 3A shows the state where the color wheel 2 is separated from the focal position of the condenser lens 3 by a distance L toward the light source section 1, whereas FIG. 3B shows the state where the color wheel 2 is separated from the focal position of the condenser lens 3 by a distance M away from the light source section 1. In FIGS. 3A and 3B, broken lines virtually show the states where the color wheel 2 is disposed at the focal point of the condenser lens 3.

The return light to the light-emitting point 11 can also be reduced when the position of the color wheel 2 on the optical axis is separated from the focal position of the condenser lens 3 as such. Though all the traced light beams A to G are reflected by the color wheel 2 and then are re-reflected by the reflector 12 in the case where the color wheel 2 is arranged nearer to the light source section 1 as shown in FIG. 3A, they are not totally converged as return light at the position of the light-emitting point 11. As depicted, the light beams are scarce at the position of the light-emitting point 11, whereby the heat generated thereby is lower than that in the state of FIG. 7. In the case where the color wheel 2 is arranged away from the light source section 1, as shown in FIG. 3B, marginal light beams such as light beams F and G are eclipsed by the lens barrel of the condenser lens 3 after being reflected by the color wheel 2, thus failing to reach the reflector 12. Therefore, the heat generated at the light-emitting position is lower than that in the state of FIG. 7.

In this embodiment, however, the position of the color wheel 2 is separated from the focal point of the condenser lens 3 and thus is different from the position where the illumination light converged by the condenser lens 3 attains the smallest luminous flux diameter. Therefore, the size of the color wheel 2 in this embodiment may become greater than that in the first embodiment if the distance L or M is too long.

Preferably, at least one surface of the color wheel 2 is formed with an infrared reflecting coat or an ultraviolet reflecting coat in this embodiment as well. This prevents these rays from being transmitted through the color wheel 2 and reduces the return light to the vicinity of the luminous tube, whereby the heat of the luminous tube 11 can be suppressed.

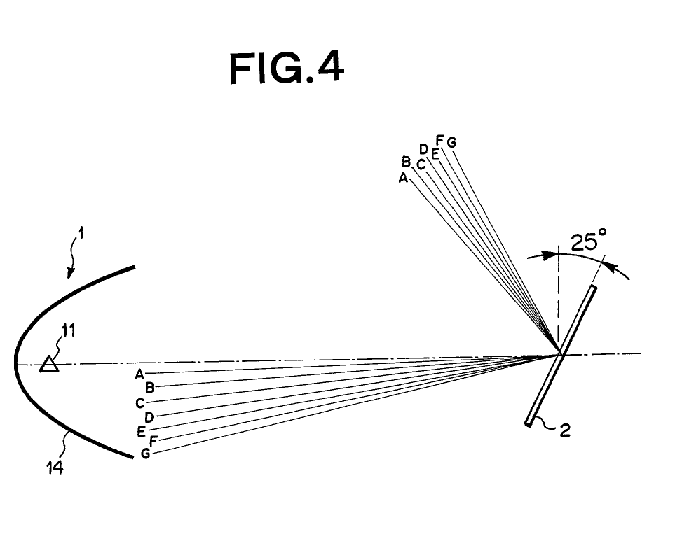

A third embodiment of the illumination optical system in accordance with the present invention will now be explained with reference to FIG. 4 showing the illumination optical system from its light source section 1 to color wheel 2 under magnification. The illumination optical system in accordance with this embodiment can be employed in a projection type color image display apparatus as with the illumination optical system in accordance with the first embodiment.

In this embodiment, the light source section 1 comprises a luminous tube (indicated as a light-emitting point 11) disposed near a first focal point of a reflector 14 made of an ellipsoidal mirror. The color wheel 2 is disposed near a second focal point of the reflector 14 on the optical axis while forming a predetermined angle with respect to the optical axis. Namely, the color wheel 2 is tilted from a position orthogonal to the optical axis to such an extent that the illumination light reflected by the color wheel 2 is not re-reflected by the reflector 14 and does not return to the luminous body 11 of the light source section 1.

This embodiment is the same as the first embodiment in that the color wheel 2 is tilted, but differs therefrom in that it uses the reflector 14 made of an ellipsoidal mirror, thereby being able to converge the illumination light at the second focal point of the reflector 14. Therefore, without requiring the condenser lens 3 for converging the illumination light to be arranged as in the first embodiment, the color wheel 2 can be disposed near a position where the illumination light attains the smallest luminous flux diameter while reducing the number of members.

As with the first embodiment, the third embodiment can be configured so as to change the angle by which the color wheel 2 is tilted, thereby reducing the return light to the luminous tube 11 or totally preventing the light reflected by the color wheel 2 from returning to the reflector 14. Therefore, the heating of the luminous tube 11 caused by the return light can be suppressed or eliminated. In order for the reflected light from the color wheel 2 to totally deviate from the reflector 14, as in the first embodiment, it will be sufficient if the color wheel 2 is tilted by at least β from the position orthogonal to the optical axis, where β is the angle formed between the optical axis and the outermost light beam emitted from the reflector 14 to the color wheel 2.

Preferably, at least one surface of the color wheel 2 is formed with an infrared reflecting coat or an ultraviolet reflecting coat in this embodiment as well. This prevents these rays from being transmitted through the color wheel 2. Also, since the color wheel 2 is tilted with respect to the optical axis, these rays can be reflected so as to deviate from the reflector without returning to the vicinity of the luminous tube 11. Therefore, the return light from the infrared and ultraviolet rays can be restrained from raising the temperature of the luminous tube 11.

A fourth embodiment of the illumination optical system in accordance with the present invention will now be explained. The illumination optical system in accordance with this embodiment comprises a light source section comprising a luminous tube disposed near a first focal point of a reflector made of an ellipsoidal mirror, and a color wheel for decomposing illumination light from the light source section into a plurality of color light components, in which the color wheel is separated from a second focal point of the reflector by a predetermined distance toward or away from the light source section along the optical axis. The color wheel is disposed substantially orthogonal to the optical axis, and is separated from the second focal point of the reflector made of an ellipsoidal mirror by a predetermined distance toward or away from the light source section on the optical axis to such an extent that the illumination light reflected by the color wheel is not re-reflected by the reflector and does not return to the luminous body.

Namely, the illumination optical system in accordance with this embodiment can be considered to be one in which the color wheel 2 is arranged as in FIG. 3A or 3B on the downstream of the light source section 1 of FIG. 4. The illumination optical system in accordance with this embodiment can converge the illumination light at the second focal point of the reflector, since it uses the reflector made of an ellipsoidal mirror as with the illumination optical system in accordance with the third embodiment. Therefore, it does not require the condenser lens 3 to be arranged as in the second embodiment, whereby the number of members can be reduced.

Also, as with the illumination optical system in accordance with the second embodiment, the illumination optical system in accordance with the fourth embodiment can reduce the return light to the light-emitting point either when the color wheel is arranged nearer to or away from the light source section from the second focal position of the reflector. Therefore, the heat at the light-emitting point can be made lower than that that in the case of FIG. 7.

Preferably, at least one surface of the color wheel is formed with an infrared reflecting coat or an ultraviolet reflecting coat in this embodiment as well. This prevents these rays from being transmitted through the color wheel and reduces the return light to the vicinity of the luminous tube, whereby the heat of the luminous tube can be suppressed.

Each of the illumination optical systems in accordance with the first to fourth embodiments explained in the foregoing is effective in reducing return light and is useful as an illumination optical system of a projection type color image display apparatus. Which configuration of illumination optical systems is most favorably employed should be chosen by experiments and the like depending on the degree of freedom in apparatus designs and the like in each case.

Also, for restraining such return light from raising the temperature of the luminous tube, a method in which the reflector or luminous tube is cooled has been employed in general. In the apparatus shown in FIG. 1, for example, a cooling section 13 is disposed near the luminous tube 11 of the light source section 1. The position of the cooling section 13 is not limited to that shown in FIG. 1. When the light source section 1 is provided with the cooling section 13 as such, the temperature rise in the luminous tube 11 can be suppressed even if it is not configured such that the light reflected by the color wheel 2 is not totally reflected to the outside of the reflector. For example, it may be configured such that the reflected light from the color wheel 2 is reflected by the reflector 12, 14 to the vicinity of the cooling section.

### EXAMPLES

Examples of the present invention will now be explained. Among the examples, members similar to each other will be referred to with numerals identical to each other.

### Example 1

FIG. 1 is a view showing the configuration of the projection type color image display apparatus in accordance with Example 1. The configuration of this apparatus will further be explained in detail.

A luminous flux from the luminous tube 11 emitting nonpolarized light is reflected by the parabolic reflector 12 so as to be forwardly emitted from the light source section 1 as substantially parallel light beams. In the light source section 1, the cooling section 13 is disposed near the luminous tube 11 in order to restrain the return light from the color wheel 2 from raising the temperature of the luminous tube 11. The illumination light proceeds from the left side to right side in the drawing and is converged by the condenser lens 3. The transmission type color wheel 2 is disposed as color decomposing means in the vicinity of the focal point of the condenser lens 3, i.e., near a position where the illumination light attains the smallest luminous flux diameter.

As in the above-mentioned first embodiment, the color wheel 2 is tilted from a position orthogonal to the optical axis to such an extent that the illumination light from the light source section 1 reflected by the color wheel 2 is not re-reflected by the reflector 12 and does not return to the luminous tube 11 of the light source section 1. This clearly reduces the light reflected by the color wheel 2 and re-reflected by the reflector 12 so as to return to the vicinity of the luminous tube 11. Therefore, the temperature rise of the luminous tube 11 can be lowered, whereby the deterioration of electrodes and the like within the luminous tube 11 can be suppressed. The surface of the color wheel 2 facing the light source section 1 is formed with an infrared reflecting coat and an ultraviolet reflecting coat.

The illumination light emitted from the color wheel 2 enters the integrator section 5 comprising a rod integrator 15. The integrator section 5 homogenizes the intensity distribution of illumination light within a cross section perpendicular to the optical axis. Within the rod integrator 15, incident light is reflected by a plurality of times before being emitted therefrom, whereby the intensity distribution of emitted light is homogenized. The rod integrator 15 is usually disposed at a position where the incident light attains a small luminous flux diameter as shown in FIG. 1. The illumination light emitted from the rod integrator 15 irradiates the image display device 9 by way of the relay lens 16 and total reflection prism 17. In this example, the image display device 9 is a digital micromirror device (hereinafter referred to as DMD). Color images are projected onto a screen by the illumination light reflected toward a projection lens (not depicted) by the DMD according to image information.

The DMD is a device comprising minute mirrors arranged in a matrix on a substrate. Each mirror corresponds to a single pixel and tilts by an angle of ±10 degrees about a diagonal line thereof. The tilting angle is switched according to the image information, so as to regulate whether or not to reflect the emitted light toward the projection lens. It is characterized by a high luminance and a very fast switching time, thereby being usable as an image display device in an apparatus using a color wheel as color decomposing means as in the present invention.

Though the configuration of the light source section 1 and the arrangement of the color wheel 2 in the apparatus of this example are the same as those explained as the first embodiment, the color wheel 2 may be arranged as explained in the second embodiment. Also, the reflector of the light source section 1 may be changed to an ellipsoidal mirror, the condenser lens 3 may be eliminated, and the color wheel 2 may be arranged as explained in the third or fourth embodiment.

### Example 2

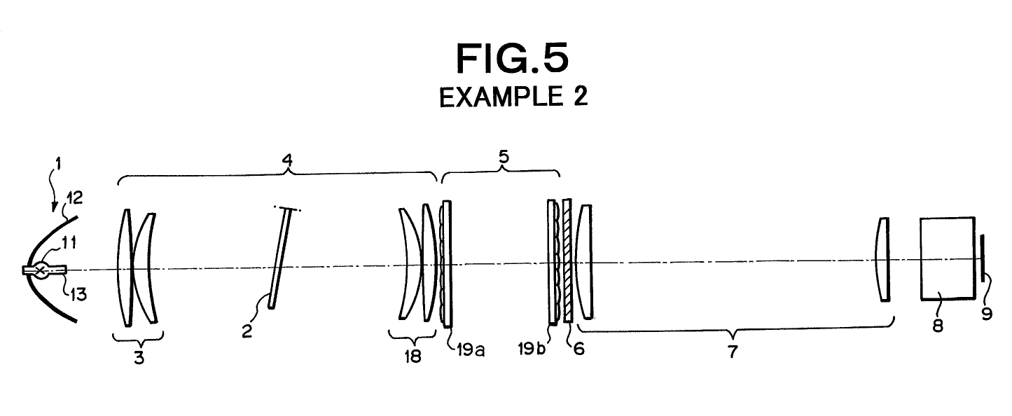

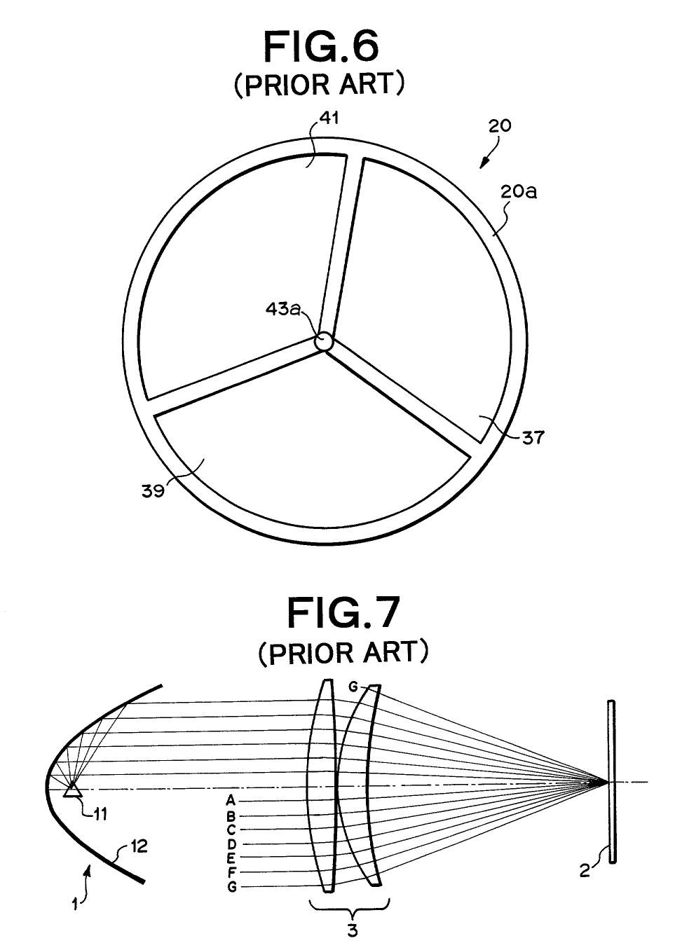

The configuration of a projection type color image display apparatus using the illumination optical system in accordance with Example 2 is shown in FIG. 5.

Substantially parallel light beams of illumination light emitted from a light source section 1 similar to that in Example 1 enters an afocal section 4. In the afocal section 4, an afocal front-group lens (corresponding to the condenser lens 3 in this example) and an afocal rear-group lens 18 constitute a substantially afocal system, whereas a transmission type color wheel 2 is disposed as color decomposing means near the focal point of the condenser lens 3 at a middle position of the afocal section 4 yielding the smallest luminous flux diameter. The afocal section 4 is disposed between the light source section 1 emitting parallel light beams and its downstream flyeye integrators 19a, 19b on which the parallel light beams are desired to be made incident. The afocal section 4 causes the illumination light to reduce its luminous flux diameter so as to make it suitable for the color wheel 2, and acts to emit parallel light beams toward the flyeye integrators 19a, 19b. The illumination light emitted from the afocal section 4 has a luminous flux diameter substantially on a par with that at the time emitted from the aperture of the reflector 12.

After being emitted from the afocal section 4, the illumination light enters an integrator section 5. The integrator section 5 homogenizes the intensity distribution of illumination light within a cross section perpendicular to the optical axis, and is made of a flyeye integrator composed of two sheets of flyeyes 19a, 19b arranged on the optical axis. Each of the flyeyes 19a, 19b is constituted by a plurality of lenses arranged two-dimensionally. The illumination light incident as substantially parallel light beams on the flyeye 19a on the light source side is split into partial luminous fluxes by individual cells of the flyeye 19a. The flyeye 19b on the image display device side is disposed near a position where a plurality of secondary light source images corresponding to the number of divisions of the flyeye 19a on the light source section are generated, and emits the partial luminous fluxes toward an area to be illuminated.

Disposed on the downstream of the integrator section 5 as polarization converting means for converting the illumination light into linearly polarized light vibrating in a single direction is a polarization converting device 6 comprising a beam splitter for dividing incident nonpolarized illumination light into first and second polarized light beams having respective polarized light components orthogonal to each other, a mirror for reflecting one of the polarized light beams separated by the beam splitter, and a phase plate for causing one of the polarized light beams to have a polarization in the same direction as that of the other. Thus, the polarization converting device 6 converts nonpolarized illumination light into light having only one of polarized light components and emits the resulting light.

The polarization converting device 6 is disposed immediately downstream the exit of the flyeye 19b on the image display device side. This position is near the position where a plurality of secondary light source images corresponding to the number of divisions of the flyeye 19a are generated, whereas the phase plate of the polarization converting device 6 corresponds to each of them. Since the secondary light source images are formed as being divided into partial luminous fluxes by the cells of the flyeye 19a on the light source section side, each secondary light source has a large F value (i.e., the angular distribution of luminous fluxes is narrow). Since the flyeye integrators 19a, 19b and the polarization converting device 6 are arranged as such, the illumination light can efficiently be converted into light having only one polarized light component. This example is configured such that all the luminous fluxes emitted from the polarization converting device 6 become P-polarized light with respect to a polarization separating film within the polarization beam splitter 8 on the downstream side. The partial luminous fluxes emitted from the polarization converting device 6 are converged by a superposition lens 7 so as to be superposed on each other in the area to be illuminated, and enter the polarization beam splitter 8.

The illumination light passes through the polarization separating film within the polarization beam splitter 8 and irradiates the image display device 9. In this example, the image display device 9 is a ferroelectric liquid crystal display device (hereinafter referred to as “FLC device”). The P-polarized illumination light having reached the FLC device is optically modulated pixel by pixel, and then reenters the polarization beam splitter 8. Subsequently, the (S-polarized) luminous flux to be projected is reflected by the polarization separating film within the polarization beam splitter 8 so as to be emitted to the projection lens (not depicted), whereby color images are projected on a screen. The luminous flux (still in P-polarized state) to be blocked, on the other hand, is transmitted through the polarization separating film, so as to return toward the illumination optical system.

The FLC device is a kind of reflection type display device which distinguishes ON and OFF states of a pixel from each other according to the direction of polarization by utilizing the optical rotation effect of a liquid crystal. In addition to features of a typical reflection type liquid crystal display device such as higher resolution and higher illumination, its most characteristic feature lies in the fast response speed to voltage applications. Therefore, it can be employed as an image display device in an apparatus using a color wheel as color decomposing means as in the present invention.

Though the configuration of the light source section 1 and the arrangement of the color wheel 2 in the apparatus of this example are the same as those explained as the first embodiment, the color wheel 2 may be arranged as explained in the second embodiment. Also, the reflector of the light source section 1 may be changed to an ellipsoidal mirror, the condenser lens 3 may be eliminated, and the color wheel 2 may be arranged as explained in the third or fourth embodiment.

Without being restricted to the above-mentioned examples, the illumination optical system of the present invention and the projection type color image display apparatus can be changed in various manners.

For example, the illumination optical system of the present invention may be configured such that the position of the color wheel on the optical axis and its angle with respect to the optical axis are made adjustable so that appropriate position and angle of the color wheel can be determined while measuring influences of return light on the luminous body.

The color wheel in the illumination optical system of the present invention is not limited to the above-mentioned transmission type. Known is not only the transmission type color wheel, but also a reflection type color wheel in which a dichroic film for reflecting only one of three primary colors of luminous fluxes is formed in one of three areas corresponding to respective primary colors. Illumination optical systems using such a reflection type color wheel will yield a problem similar to that in the transmission type color wheel if a part of the illumination light reflected by the color wheel returns to a reflector. Therefore, it is preferred that the reflection type color wheel be tilted by at least a predetermined amount with respect to the optical axis of incident light onto the color wheel.

Also, the color wheel in the present invention is not limited to one in which an area for transmitting or reflecting primary color light components is equally divided into three. Any of the divided areas may be wider or narrower than the others. Also, areas for transmitting or reflecting color light components other than the three primary color light components, such as white light or a color light component mixing two of the three primary light components may be formed.

Though the above-mentioned examples of the projection type color image display apparatus in accordance with the present invention relate to a case where the integrator section is a rod integrator whereas the image display device is a DMD, and a case where the integrator section is a flyeye integrator whereas the image display device is an FLC device, any combination of integrator section and image display device can be employed. Whether the integrator section is a rod integrator or flyeye integrator, and whether the image display device is a DMD or FLC device can be decided differently from the combinations mentioned in the examples. Depending on the image display device, it is preferred that a polarization converting device be inserted upstream thereof. The configuration of the polarization converting device may vary depending on the state of luminous flux emitted from the integrator section. Further, depending on these combinations, the lens system from the integrator section to the image display device may vary. Therefore, though these combinations are arbitrary, integrity is necessary for the apparatus as a whole.

The image display device in the projection type color image display apparatus in accordance with the present invention is not limited to the DMD and FLC device, but may be other image display devices such as conventional liquid crystal display devices of transmission and reflection types.

In the illumination optical system of the present invention and the projection type color image display apparatus using the same, as explained in the foregoing, the color wheel is arranged with a predetermined angle near a position where the illumination light attains the smallest luminous flux diameter or is arranged substantially orthogonal to the optical axis while being separated from the position where the illumination light attains the smallest luminous flux diameter by a predetermined distance along the optical axis, whereby the return light reflected by the color wheel so as to return to luminous tubes can be reduced. Therefore, the deterioration of luminous tubes caused by return light can be alleviated or eliminated.

What is claimed is:

1. An illumination optical system comprising a reflector for forwardly reflecting illumination light emitted from a luminous body, and a color wheel for decomposing said illumination light from said reflector into a plurality of color light components; wherein said color wheel is disposed with a predetermined angle with respect to an optical axis.

2. An illumination optical system according to claim 1, wherein said reflector comprises a parabolic mirror, said luminous body is disposed near a focal point of said parabolic mirror, a condenser lens for converging said illumination light from said reflector is provided, and said color wheel is disposed near a focal point of said condenser lens.

3. An illumination optical system according to claim 1, wherein said reflector comprises an ellipsoidal mirror, said luminous body is disposed near a first focal point of said ellipsoidal mirror, and said color wheel is disposed near a second focal point of said ellipsoidal mirror.

4. An illumination optical system according to claim 1, wherein said color wheel is a transmission type color wheel.

5. An illumination optical system according to claim 4, wherein said transmission type color wheel has a transmitting area equally divided into three for transmitting therethrough three primary color light components, respectively.

6. An illumination optical system according to claim 1, wherein said color wheel is a reflection type color wheel.

7. An illumination optical system according to claim 6, wherein said transmission type color wheel has a reflecting area equally divided into three for reflecting three primary color light components, respectively.

8. An illumination optical system according to claim 1, wherein at least one surface of said color wheel is formed with an infrared reflecting coat.

9. An illumination optical system according to claim 1, wherein at least one surface of said color wheel is formed with an ultraviolet reflecting coat.

10. A projection type color image display apparatus comprising the illumination optical system according to claim 1, and an image display device for optically modulating said illumination light emitted from said illumination optical system.

11. A projection type color image display apparatus according to claim 10, wherein said image display device is a ferroelectric liquid crystal display device.

12. A projection type color image display apparatus according to claim 10, wherein said image display device is a digital micromirror device.

13. A projection type color image display apparatus according to claim 10, wherein, in said illumination light decomposed into a plurality of color light components in said color wheel, a color light component transmitted through said color wheel is guided to said image display device.

14. A projection type color image display apparatus according to claim 10, further comprising an integrator section for homogenizing an intensity distribution of said illumination light within a cross section perpendicular to said optical axis.

15. A projection type color image display apparatus according to claim 14, wherein said integrator section is a rod integrator.

16. A projection type color image display apparatus according to claim 14, wherein said integrator section is a flyeye integrator.

17. A projection type color image display apparatus according to claim 10, further comprising a polarization converting device for converting said illumination light into light having only one polarized light component.

18. An illumination optical system comprising a light source section comprising a reflector made of a parabolic mirror, and a luminous body disposed near a focal point of the reflector; a condenser lens; and a color wheel for decomposing illumination light from said light source section into a plurality of color light components; wherein said color wheel is separated from a focal point of said condenser lens by a predetermined distance toward or away from said light source section along an optical axis.

19. An illumination optical system according to claim 18, wherein at least one surface of said color wheel is formed with an infrared reflecting coat.

20. An illumination optical system according to claim 18, wherein at least one surface of said color wheel is formed with an ultraviolet reflecting coat.

21. A projection type color image display apparatus comprising the illumination optical system according to claim 18, and an image display device for optically modulating said illumination light emitted from said illumination optical system.

22. A projection type color image display apparatus according to claim 21, wherein said image display device is a ferroelectric liquid crystal display device.

23. A projection type color image display apparatus according to claim 21, wherein said image display device is a digital micromirror device.

24. A projection type color image display apparatus according to claim 21, wherein, in said illumination light decomposed into a plurality of color light components in said color wheel, a color light component transmitted through said color wheel is guided to said image display device.

25. An illumination optical system comprising a light source section comprising a reflector made of an ellipsoidal mirror, and a luminous body disposed near a first focal point of said reflector; and a color wheel for decomposing illumination light from said light source section into a plurality of color light components; wherein said color wheel is separated from a second focal point of said reflector by a predetermined distance toward or away from said light source section along an optical axis.

26. An illumination optical system according to claim 25, wherein at least one surface of said color wheel is formed with an infrared reflecting coat.

27. An illumination optical system according to claim 25, wherein at least one surface of said color wheel is formed with an ultraviolet reflecting coat.

28. A projection type color image display apparatus comprising the illumination optical system according to claim 25, and an image display device for optically modulating said illumination light emitted from said illumination optical system.

29. A projection type color image display apparatus according to claim 28, wherein said image display device is a ferroelectric liquid crystal display device.

30. A projection type color image display apparatus according to claim 28, wherein said image display device is a digital micromirror device.

31. A projection type color image display apparatus according to claim 28, wherein, in said illumination light decomposed into a plurality of color light components in said color wheel, a color light component transmitted through said color wheel is guided to said image display device.
